(19) United States
(12) Patent Application Publication
(10) Pub. No.: US 2006/0010251 A1
(43) Pub. Date: Jan. 12, 2006

(54) Global community naming authority

(75) Inventors: Janko Mrsic-Flogel, London (GB); Sakari Rahkila, Espoo (FI); William J. Yeager, Menlo Park, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/869,687

(22) Filed: Jun. 16, 2004

(51) Int. Cl. G06F 15/16

(52) U.S. Cl. 709/245

(57) ABSTRACT

Provided are improved systems for a global community naming authority and methods for naming global communities. A global community naming authority may be used to register online communities to create a universal unique identifier for each registered online community. A global community naming authority may be used to control generation of new online communities to ensure that a universal unique identifier exists for new online communities that may be used by online users. A method for naming global communities includes certifying a universal unique name for all registered and newly created online communities. Existing online communities may be migrated into a global community name database. Existing communities not formalized as online communities may be mapped into online communities by a global community naming authority.

### FIELD OF THE INVENTION

The present invention relates generally to systems and methods for community naming and, more particularly, to systems and methods for naming of communities for a global, multiple-level peer-to-peer network.

### BACKGROUND

User communities have been and continue to be popular organizational entities of computer and other electronic device users. Many companies such as Yahoo!®, Apple®, Microsoft®, MSN®, and AOL® provide users the ability to register their user account with groups of other users such as discussion and fan groups. For example, a user may join the Classical Music group of Yahoo!®, the iTunes® group of iMac®, or any of the groups at portal sites such as groups.MSN.com or groups.Yahoo.com. Other companies effectively create groups of clients or users. For example, users may establish accounts at and/or become customers of Amazon.com®, Match.com®, ESPN.com®, and BBC.co.uk. These and other types of groups may generally be referred to as communities, whereas different groups of users may have different purposes, but all groups may be referred to as ‘communities’ of users. Communities often are provided on the Internet to bring together friends, family, and/or individuals with related interests. Communities are a way to connect to, share information with, and communicate with other users. For example, users communicate through the AOL® Instant Messanger™ community. Communities may be used for such purposes as chatting, discussions, file sharing, photo albums, polls, calendars, or practically any peer-to-peer or multi-user function. Many groups are single-purpose communities, but some community services offer functionality for multiple purposes, such as a group that provides for messaging, holding a discussion, and sharing photos.

Communities exist online, on the Internet and other networks, and in corporate and social environments. For example, organizational topologies, such as hierarchies, cross-sectional strands, loose associations, and other bindings, exist in corporate environments and social groups. All of the employees of a division of a parent company may be members of the parent company community and also of the division community. Smaller segments of a corporate environment may form communities such as a research and development community, within a corporate entity or across divisions of a larger corporate parent. For example, a strategy employee of BBC Vecta may be a member of the BBC Vecta Staff community and the BBC Strategy community. Members of a social organization such as the Boy Scouts of America may be members of the national organization community, a local council community, an eagle scout community, and other communities of the organization. Even communities not traditionally online are becoming online with the proliferation of e-mail and other online features of an organization, such as online registration, payment, accounts, and websites.

More and more users are establishing network presence on multiple communities with, effectively, separate entities at each of these communities. Similarly, more and more users are joining communities with different types of end-user devices, such as desktop personal computers, laptop personal computers, television Internet access devices, wireless personal portable devices, and mobile phones. Regardless of the type of device used, each situation involves the commonality that a user is connecting with other peers using a network. This type of network may be generally referred to as a peer-to-peer network. Although user groups are not typically considered to be peer-to-peer networks, user groups may be referred to as peer-to-peer communities. And as user groups continue to provide users better access and functionality, such as a user of a mobile phone accessing a user group or sending an AOL® Instant Messenger™ message to another user of the AOL® Instant Messenger™ community or a user of a personal digital assistant (PDA) might access a fantasy sports community during a game to leave a message in a discussion group, communities and traditional peer-to-peer networks become more alike.

A traditional peer-to-peer (P2P) network is a type of temporary network in which users connecting with one another through a communication network, such as the Internet, directly connect with one another's computers through a P2P application and transmit and receive various information, data, and files between the interconnected users. P2P networks are often described as file sharing networks and widely popular for sharing of MP3 files, but are used for many other purposes and with any type of file. Unlike a standard client/server model, traditional P2P denotes a shared network, in which personal computers directly connect with and search one another, where participants may be both suppliers and consumers of the information, data, and files of the network. P2P can be implemented by a method in which connections among individuals can be achieved with the aid of a server and by another method in which individuals share personal information, such as Internet Protocol (IP) addresses, and directly connect with one another without the aid of a server. Peers that connect with one another designate digital devices such as computers, Personal Digital Assistants (PDAs), mobile phones and the like as computers of the P2P network. Representative examples of such a P2P shared network are Napster, JXTA, Soribada, and Kazaa. However, one problem with P2P networks are their temporary and ever-changing nature. A traditional P2P network in general is not persistent, but relies upon the end-user devices to form the P2P network which forms an ad-hoc network of user devices. As end-user devices come online and go offline, the P2P network changes. Reliability for sharing information is only as good as the status of the end-user devices being online to share their information. Furthermore, users of a P2P network cannot benefit from the existence of the P2P network unless the user has a device online functioning as part of the P2P network. Even P2P networks that use super-peers to moderate network behavior suffer from the instability of the reliability of the peers because, typically, the P2P software runs in the peer user devices. Thus, presence detection in traditional P2P networks is difficult and unreliable.

An added complexity of the growing popularity of traditional P2P networks is the use of cellular telephones and other mobile terminals as end-user devices. Users of mobile devices are now able to access P2P networks. However, unlike devices which are connected to the network all the time (“always-on” or 24/7 devices), a mobile device only remains part of the P2P network as long as a wireless connection is provided between the device and the network. And due to limited cellular bandwidths, many users of mobile devices are restricted as users of P2P networks. This and other limitations of mobile devices as users of P2P networks reduces the overall efficiency and reliability of the network for all users where mobile users may connect to and disconnect from the network without remaining connected for long periods of time, permitting the network to benefit from the existence of another device on the network with which to share information, data, and files. Similar limitations exist for devices which are not cellular mobile devices where computers are connected to and disconnected from P2P networks, but with typically less frequency and longer durations due to common network connections such as fixed and/or always-on DSL and cable modem network access connections.

Another added complexity of traditional P2P networks is a user with multiple devices which may be mobile or situated in different geographical locations. Each device appears on the network as a different network node as if the user were multiple users each with one device. Even where a user has a device which is always-on, when the same user attaches another device to the network, the user is represented by two nodes. This device-independent characteristic of traditional P2P networks prevents a user from having a single personality on a P2P network and prevents the user from coordinating and combining information, data, and files of each of the devices of the user into a single entity or node on the network. Similar limitations restrict SMS and other network operations where a single user has multiple devices that may be used by the user to connect to one or more networks.

Similarly, users of groups typically have to create an account or local user for each group site. For example, a user may need to have an AOL® user account, a Yahoo!® account, an ESPN® account, and a BBC® account to be members of these communities. A user may be able to join multiple groups with one user account at a group portal site such as groups.MSN.com or groups.Yahoo.com. But users cannot create a single network personality that can be used to join or become associated with any type of network community. As user groups and other types of communities such as P2P networks continue to evolve, users are becoming and/or will become overwhelmed and frustrated with the redundancies and problems associated with all of the various user groups and other communities of which the user is a member, such as keeping track of numerous online accounts and passwords and a user not being able to organize all of his or her communities together under one online network entity. Users would benefit from a single online network entity, a single sign-on, and a means to organize and associate the single online network entity with all online network communities.

Accordingly, an improved community naming system and method is needed that may interface with a system for single online network entities.

### SUMMARY

In light of the foregoing background, embodiments of the present invention provide improved systems and methods for a global community naming authority. A global community naming authority of an embodiment of the present invention may be used with online communities such as P2P networks, corporate organizational structures, social classifications, structures, and memberships, and other online, electronic, and/or networked communities (hereinafter collectively referred to as communities or online communities).

Embodiments of the present invention provide a single community naming authority to coordinate, certify, and authorize existing and new online communities.

In order to better understand the potential use of embodiments of the present invention in addition to use in the context of existing online communities, also provided herein is an improved two-stage P2P network, or Peerouette-Network, that provides the capability of establishing a single online network entity, or peersona, for each user. Thus, embodiments of the present invention are described with reference to use in the context of both existing online communities and the described Peerouette-Network of peersonas.

The Peerouette-Network, an improved P2P network, may provide an always-on, or 24/7, reliable two-stage network for P2P internetworking and end-user access. A Peerouette-Network optimizes and personalizes the delivery of multimedia content to multiple user devices. A Peerouette-Network may be used to provide a global P2P network (hereinafter referred to as a “Peerouette-Net” of users or the “Peerouette-Network”). By distributing the P2P network across two stages, a Personal Server layer and an edge-peer layer, the Peerouette-Net provides a hierarchy network for communicating and distributing data such as multimedia content. The Personal Server layer maintains a consistent P2P infrastructure by providing persistent 24/7 uptime of entities representing users, or peersonas. A Personal Server serves in the roll of both client and server, client and server to the P2P network and server to the end-user devices. The peersona is the presence of the associated user on the P2P network as exhibited through the Personal Server. A Peerouette-Net may be incorporated within the infrastructures of wireless and broadband service providers. Further, a Peerouette-Network and peersonas thereof provide for secure and reliable communications, efficient network performance, and a new user experience while respecting copyright and other digital rights management controls. Finally, the P2P functionality, including content storage, typically resides in the peersonas and not in the end-user devices, thereby yielding an always-on P2P network even if the edge-peers are off-line.

An embodiment of a global community naming authority of the present invention may include a memory, a processor, a network interface, a community name database and a community name authorization module. The processor may be interoperably coupled to the memory, the network interface, the community name database, and the community name authorization module. The network interface may provide for communication with external systems and networks such as to receive a request for a community name for a new community or to register an existing online community. The processor may be able to access, search, or modify the community name database, which may also be referred to or characterized as a community name registry or table. The processor may be able to process requests for community names received through the network interface with the community name authorization module. A community name database of an embodiment of the present invention may comprise a record for every registered online community. And a processor of a global community naming authority of an embodiment of the present invention may be further capable of adding or deleting records from a community name database. A community name authorization module of an embodiment of a global community naming authority of the present invention may provide community name information to the processor for adding a new record to the community name database. A community naming authority may be capable of generating universal unique identifiers for online communities registered with the community naming authority. A peersona may also be capable of generating universal unique identifiers for online communities that may or may not be registered with the community naming authority. Typically, peersona-generated universal unique identifiers cannot be certified by a peersona. Rather, a community naming authority has the exclusive power of certification. A universal unique identifier of a registered and certified online community may be a name, such as a universal unique name. In one embodiment of a global community naming authority of the present invention, a community naming authority may be capable of generating both a universal unique identifier and a universal unique name for a registered online community that is registered.

A method of naming global communities may include the steps of migrating existing online communities into a global community name database, assigning each of the existing online communities a certified, universal unique identifier, and registering new online communities in the global community name database with such a universal unique identifier. The universal unique identifiers for the existing online communities and the new online communities may be stored in the global community name database as a binding of each of these online communities. Universal unique identifiers of existing online communities and/or new online communities may include certified, universal unique names. Alternatively, one embodiment of a method for naming global communities of the present invention may include the step of assigning each of the existing online communities a certified, universal unique name, where each universal unique name is stored in the global community name database as a binding of the existing online community and the universal unique identifier for the existing online community. Similarly, one embodiment of a method of naming global communities of the present invention may include the step of registering the new online communities with a certified, universal unique name, where the universal unique name is stored in the global community name database as a binding of the new online community and the universal unique identifier for the new online community. Therefore, an embodiment of a method of naming global communities of the present invention may also include the step of certifying an existing or new community of an external system or network or the step of managing an existing or new community of an external system or network. One embodiment of a method of naming global communities of the present invention includes the step of mapping non-formalized communities into registered online communities in the global community name database with a universal unique identifier for each of said registered online communities of said mapped non-formalized communities. A further embodiment of a method of naming global communities of the present invention includes the step of adding online communities to the global community name database.

An embodiment of a method of naming global communities of the present invention may include the steps of receiving requests for naming an online community, assigning a universal unique identifier to the online community of the request, and registering the online community of the request in a global community name database. The universal unique identifier may be a binding of the registered online community. One embodiment may further include the step of providing the requests for naming an online community. Such an online community may be an existing online community. Another embodiment may include the step of generating the request for an online community for an existing online community. A universal unique identifier may comprise a name, such as a universal unique name. An embodiment of a method of naming global communities of the present invention may include the step of assigning a universal unique name to the online community of a request for naming an online community. The universal unique name may be a binding of the universal unique identifier of the registered online community. A further embodiment of a method of naming global communities of the present invention may include the step of certifying an existing or new community of an external system or network or the step of managing an existing or new community of an external system or network.

An embodiment of a service provider for naming and/or managing global communities of the present invention is provided. Such a service provider may include an interface for receiving a request for naming an online community, a processor logic for assigning a universal unique identifier for the online community, and a processor logic for registering the online community in a global community name database. The universal unique identifier may be a binding of the registered online community in the global community name database.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is an embodiment of a peersona of a Peerouette-Network;

FIG. 2 is an embodiment of a Peerouette-Network;

FIG. 3a is an embodiment of the separation of an association of a peersona community;

FIG. 3b is an embodiment of a peersona community;

FIG. 3c is an embodiment of the mapping of a peersona community;

FIG. 4 shows peersonas, sites, and regions of the Peerouette-Net;

FIG. 5 shows peersonas, sites, regions, and a peersona community of the Peerouette-Net;

FIG. 6 is a diagram of a peersona and a diagram of communication between peersonas;

FIG. 7 is device connection portal using web access to a peersona;

FIG. 8 is a community, device connection, and services and application portal of a peersona seen from a Personal Server Management Console;

FIG. 9 is an acceptance portal of a device connection to a peersona;

FIG. 10 is a device connection portal requesting a peersonaIdentity and password for connection to a Personal Server;

FIG. 11 is a block diagram of two stages of the process of service or content configuration of a Peerouette-Net;

FIG. 12 is a block diagram of two stages of computer program code updating and service configuration management of a Peerouette-Net;

FIG. 13 is a block diagram of an entity capable of operating as a network node of an embodiment of the present invention;

FIG. 14 is a block diagram of a mobile terminal capable of operating as an edge-peer of a Peerouette-Network and to function with a global community naming authority of an embodiment of the present invention; and

FIG. 15 is a block diagram of a global community naming authority of an embodiment of the present invention in communication with existing online communities, non-formalized communities, and new communities in accordance with the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While a primary use of the present invention may be in the field of online user groups and mobile phone technology communication groups, it will be appreciated from the following description that the invention is also useful for any type of online community of users. Further, while a primary use of a Peerouette-Network and peersonas thereof may be in the field of mobile phone technology, it will be appreciated from the following that many types of devices that are generally referenced herein as mobile terminals, including, for example, mobile phones, pagers, handheld data terminals and personal data assistants (PDAs), portable medical devices, personal multimedia units and music systems such as video or audio players (e.g., MP3 players), portable personal computer (PC) devices, electronic gaming systems, global positioning system (GPS) receivers, and other portable electronics, including devices that are combinations of the aforementioned devices may be used with a Peerouette-Network and peersonas. Similarly, one of ordinary skill in the art will recognize that, while a Peerouette-Network and peersonas are particularly useful for mobile and wireless devices, a Peerouette-Network and peersonas can be used with other devices and systems, such as desktop personal computers (PCs), televisions and television control boxes such at set-top boxes, and other dedicated devices that may benefit from internetworking associated with a particular user including smart devices such as refrigerators, electronic white boards, security systems, various sensors or imaging devices, and cars.

An embodiment of a global community naming authority of the present invention may be included as part of or associated with a Peerouette-Network, such as part of or co-located with but logically separate from an upper level Peerouette-Newtwork control server such as a Central Certificate Authority server, Community Central Community Naming Authority Web Service server, or a Hosting Central Server Management Web Service server. Combining a global community naming authority with a Peerouette-Network may provide for efficient coordination of communities and peersonas. Alternatively, an embodiment of a global community naming authority of the present invention may be a separate entity and/or system from a Peerouette-Network, but interoperably connected thereto, to permit the global community naming authority to have a separate existence and control from peersonas and/or the communities for which the global community naming authority provides registration, certification, management, and other functionalities and services.

In embodiments of a Peerouette-Network, a user is assigned or ‘owns’ a Personal Server which stores and represents the user's “peersona” on a network. A Personal Server may be embodied as a software bundle, typically including a collection of services and agents that represent the user, deployed on a server hardware platform, or modulator. Because a modulator may be embodied as an always-on server, the user's Personal Server, or peersona, is available 24/7. Together, the Personal Server and end-user devices, or edge-peers, are able to manage applications and services for network functionality and content data and data files such as electronic messages such as SMS, EMS, MMS, or electronic mail, VoIP, and multimedia content such as movies and audio. The peersona is the point of first contact for P2P communication. A peersona and an edge-peer may communicate using a peersona-edge-peer protocol such as a small protocol handler that may be configured to minimize bandwidth communication between the Personal Server of the peersona and the edge-peer.

Applications and services may be split in functionality between the Personal Server and edge-peers associated with the Personal Server. By splitting the functionality, and associated computer software code and processing, each application and service can be optimized in various manners such as to reduce bandwidth between a Personal Server and an edge-peer, minimizing computer program code storage on an edge-peer, and simplifying application and services computer program code update or upgrade by increasing such activity on a Personal Server and decreasing such activity on edge-peers. For example, a software application resident on a Personal Server may be upgraded on the Personal Server without needing to upgrade any software application or related computer program code on the edge-peer, thus, greatly simplifying the process of disseminating updates and performing updates of computer program code. This split application and service functionality is referred to as Peered Device Service Configuration, referring to the configuration of what elements of an application or service are executed, stored, etc. on an edge-peer or a Personal Server.

Further, because a Personal Server runs 24/7 on a modulator, functions may be invoked by and/or for a peersona of a Personal Server even when all associated end-user devices, or edge-peers, are switched off or otherwise unavailable or disconnected (offline) from the Personal Server and the network. Thus, a Personal Server and the peersona that it represents may remain on a network for communicating with other Personal Servers and their respective peersonas on behalf of the users of the peersonas while the users may be away and while the edge-peers of the users may be offline. The P2P functionality of the Peerouette-Net resides in the peersonas and not in the end-user devices. The end-user devices are clients of the P2P services that reside in the peersonas, the peersonas being the network entities or peers in the Peerouette-Net. The separation between a peersona of a P2P network and the end-user devices of the peersona also permits a user to have improved mobility since the user can always contact his or her peersona on the network regardless of location, such as when traveling. A Personal Server and a peersona refer to the same network entity, although the two terms have been used separately to aid in understanding of a hardware and software aspect of a peersona of the present invention (generally referred to as a Personal Server) by comparison to a network entity aspsect of a peersona of the present invention (generally referred to as a peersona). Therefore, any collective references to the two terms does not refer to the two terms as separate devices or entities but as one peersona which may be though of as being embodied by a Personal Server of a Modulator or other hardware and software device. A Personal Server may be referred to herein to represent a network entity of peersona or of a user in accordance with the present invention. Similarly, a peersona may be referred to herein to represent a hardware or software element of a network entity of a user of a peer-to-peer network in accordance with the present invention.

The Personal Server provides a central personal data repository for holding content files such as movies, audio, and text. Thus, a user is able to build a single peersona for all of the content of the user, independent of a particular device used by the user. In similar fashion, the Personal Server can also be used to backup end-user devices onto the Personal Server and provide device restoration from the Personal Server. For example, if a user loses a mobile phone, the user can restore the last available backup of the lost phone from the Personal Server onto a new mobile phone. The Personal Server also provides the ability to perform configuration management of applications and services such as by changing settings required for an application or service, deploying software, and updating or upgrading computer program code. Configuration management may even perform updating or upgrading of operating systems on edge-peers. A Personal Server may also store digital rights information for a user such that a user may be able to access content available in the digital rights catalog of the user on any of the edge-peers of the user. Thus, digital rights management (DRM) may be preserved, and even efficiently and seamlessly extended to new uses, devices, and contents. For example, an escrowed storage may be used on a Personal Server for downloaded content not available in the digital rights catalog of a user stored in the peersona of the user. Upon obtaining digital rights for the content, the content may be moved from escrow storage on the Personal Server of the user to the content storage for the user to allow the user to manage and/or view or otherwise access the content such as through an edge-peer.

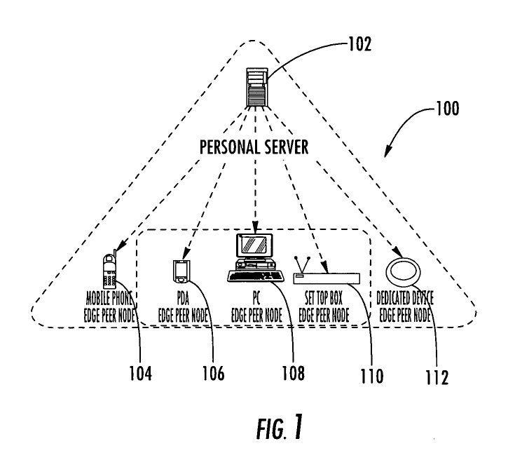

FIG. 1 is an embodiment of a peersona of a Peerouette-Network. A peersona 100 is the presence of an associated user on a P2P network as exhibited through a Personal Server 102. The Personal Server 102 is connected to different devices of the user such as a mobile phone 104, a personal digital assistant (PDA) 106, personal computer (PC) 108, television set top box 110, and dedicated devices 112. Each of these user devices may be referred to as an “edge-peer”. The user's profile or entity presence on the Personal Server 102 creates the peersona 100 of the user as a perceived network presence of the user. A peersona is a user's private, personal agent acting on behalf of the user on a network such as a P2P network. Thus, when referring to a peersona, the reference is implicitly referring to the user. The combination of all of the user's edge-peers may be described as the user's device family. A user may have any number of edge-peers associated with the user's Personal Server as part of the user's peersona. A dedicated device or dedicated edge-peer generally has a single purpose such as a home gateway, a GPS receiver, or an MP3 player, unlike a mobile phone or a personal digital assistant which may be used for multiple purposes. The differentiation between a single purpose and a multipurpose device is irrelevant to the use of the device as an edge-peer associated with a Personal Server of a peersona.

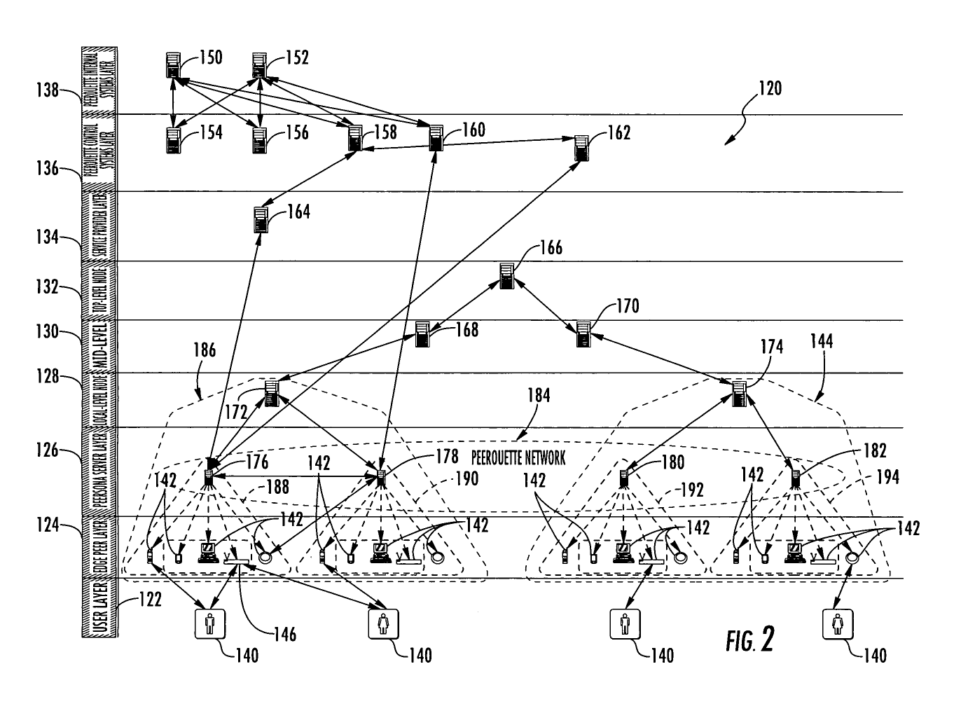

FIG. 2 is an embodiment of a Peerouette-Network. Example layers of an embodiment of a Peerouette-Net 120 are shown on the left side of FIG. 2. The bottom layer or user layer 122 represents the users of the Peerouette-Net, specifically the end user 140 of devices or edge-peers of the Peerouette-Net 120. Above the user layer 122 is the edge-peer layer 124 which includes each of the end-user devices or edge-peers 142, 146 associated with Personal Servers 176, 178, 180, 182 of peersonas 188, 190, 192, 194. An edge-peer 142 may be used by a single user or may be a multiple-user device 146 such as a television set top box used by two users of a family which may be associated with the peersona of each member of the family. A multiple user device 146 may be associated with a single Personal Server or may be associated with multiple Personal Servers (not shown). Above the edge-peer layer 124 is the Personal Server layer 126 including the Personal Servers associated with the edge-peers 142, 146. A collection of Personal Servers 176, 178, 180, 182 may be referred to as a Peerouette-Network or Peerouette-Net 184. More broadly the entire network including peersonas regional authorities, management systems, bill payment systems, hosting management, and other services, applications, and content servers may be included as part of the general or overall Peerouette-Network. By analogy to a traditional peer-to-peer (P2P) network, the Peerouette-Net would refer to simply all of the Personal Servers in such a manner as to capture each of the peersonas of the users of the network. For example, the collection of Personal Servers 176, 178, 180, 182 provides a Peerouette-Net of users 140 for each of the associated peersonas of 188, 190, 192, 194 of the users 140. Above the peersona server or Personal Server layer 126, are additional network support layers for such services and management as billing and routing. As shown in the embodiment of a Peerouette-Network of FIG. 2, a local level node layer 128 includes peersona regional authority local routing servers and web service servers 172, 174. The regional authority servers 172, 174 provide routing and other services to peersonas or Personal Servers in the respective region of the peersona regional authority. For example, a region 186 is controlled by a regional authority 172 over Personal Servers 176, 178. Higher layers such as mid-level nodes 130 and top-level nodes 132 may further coordinate communications with and between regional authorities of the Peerouette-Network. A service provider layer 134 may include a content provider or other type of content service provider or root node. A content provider server 164 may be part of a Peerouette-Net controlled by a wireless or broadband service provider or may be an external content provider. If the content server 164 is an external content provider, a content services authority 158 may control the content provided by the external content provider to the Personal Servers of the Peerouette-Network. A Peerouette control systems layer 136 may include a peer central peer management system and web service 154, a community central community naming authority web service 156, peersona services central services authority web service 158, hosting central server management web service 160, and a peersona service root node 162. These Peerouette control system layer servers provide different functionality associated with the Peerouette-Net, Peerouette-Net supporting server layers, and relationships with external parties. A Peerouette internal systems layer 138 may include a billing central billing payment system web service 150 and a central certificate authority web service 152. These and other functions and servers are described further herein with reference to these servers.

As visible from the embodiment of a Peerouette-Network of FIG. 2, a Personal Server may be both a client and a server providing server services to edge-peers and client and server services to other Personal Servers and higher layer servers such as regional authorities, content providers, and hosting central servers. By using Personal Servers to represent peersonas on the Peerouette-Net, the Peerouette-Net provides a peer-to-peer network which is device independent. That is, the edge-peers do not need to be connected to or available to the Personal Servers for the peersonas of the users to exist on the network and interact with other peersonas and network control servers in a true P2P fashion. The Personal Servers allow for an infrastructure that provides a persistent, 24/7 uptime of Personal Servers or peersonas for each user.

One or more Personal Servers or peersonas may appear on a single machine referred to as a Peerouette-Net modulator or simply a modulator. For example, Personal Server 176 and Personal Server 178 of FIG. 2 may actually reside on the same modulator. By comparison, Personal Server 180 and Personal Server 182 may appear on two separate modulators. Any number of multiple peersonas may reside on a single modulator. Modulators may be grouped at sites or geographic locations where the modulators may be directly connected or internetworked. The use of modulators is primarily designed for hardware requirements to reduce the number of hardware servers which are used to store each of the peersonas of the Peerouette-Net. Further, by using a single modulator to represent multiple Personal Servers or peersonas, the communications between peersonas may be condensed in such a manner as to reduce the physical locations of hardware to which communication interfaces may need to be available. Further, by using modulators the support services for Personal Servers may be condensed such as by reducing the number of machines to which an update or upgrade of computer program code would need to be distributed and executed or reducing the size of and streamlining the maintenance of local, site-wide modulator maps. Several modulators or sites of modulators may be organized into regions such as a region 186 representing a collection of Personal Server 176 and Personal Server 178 under the control of peersona regional authority 172. The regions are used primarily for simplification of routing of communication between peersonas and the associated modulators of peersonas. Thus, one may view the broad or more general Peerouette-Network as a geographically defined collection of modulators and the associated peersonas of the modulators into sites and regions. However, the organization and internetworking of the broader Peerouette-Network is simply provided for the ability of the Personal Servers of each of the peersonas to be able to communicate efficiently with all of the other Personal Servers on the Peerouette-Network. As described as geographically defining a collection of modulators, a site may be a city, a part of a city, several villages, a county, a department of a company, a company, or any other type of associated region whether business or physical. The organizational architecture of the Peerouette-Network into sites of modulators is intended to maximize the efficiency of communication when the expectation is that most communication will be site-local such as through communication between modulators of a single site. The Peerouette-Net is built in regions to provide for efficient communication between sites in the same region and for communication with Personal Servers in other regions. The Peerouette-Net, so organized, yields a global P2P Network of peersonas that are online and active 24/7. One of ordinary skill in the art will recognize that the organizational architecture of the Peerouette-Net may be comprised of any organized structure of Personal Servers or modulators that provides for efficient communication between Personal Servers or peersonas of the Peerouette-Net.

Each entity in the broader Peerouette-Network maintains a unique identity to provide for routing of communications between Personal Servers and between control servers and Personal Servers or modulators of the Peerouette-Network. For example, each peersona is assigned a peersonaIdentity; each modulator is assigned a modulatorIdentity; each site is assigned a peerouetteSiteIdentity; and each region is assigned a regional Peerouette-Net authority identity or RPNAIdentity (RPNAID). Devices which have associated IP addresses would have a binding between the Peerouette-Network unique identification and the IP address of the device, such as {RPNAIdentity, RPNA IP-address} and {modulatorIdentity, modulator IP-address}. A peersona only needs to know its peersonaIdentity because its communication is regulated by its modulator. Modulators may likely have knowledge of all other modulators at its site and knowledge of the peerouetteSiteIdentity of its site and the RPNAIdentity of its region, as well as the IP-address of such identifications. Each regional Peerouette-Network authority (RPNA) has knowledge of the RPNAIdentity other regional Peerouette-Net authorities, as well as the IP-address of such devices. A Peerouette-Network Router Central or Hosting Central server may provide such RPNAIdentity and IP-address combinations and/or other identification information. For example, regional Peerouette-Network authorities may also maintain routing tables for sites, modulators, and/or peersonas. These tables may be generated by the network or maintained from activity between regional Peerouette-Network authorities and sites, modulators, and/or peersonas. Through bindings, an IP address of a modulator, and, thus, a peersona, may be acquired from a lookup of its Peerouette-Network Identity, and the reverse, such that information, data, or content sent to an IP address on the Peerouette-Network may be delivered at the appropriate server or peersona.

By comparison to a traditional P2P network, each edge-peer of a traditional P2P network would be uniquely identified on the network, but in the Peerouette-Network, peersonas are provided the unique identities for user entities of the P2P network. This provides gains of performance and reliability of the Peerouette-Net because the Peerouette-Net is not affected by the reliability or accessibility of the edge-peers of the user. Peersonas, or more particularly, Personal Servers may be highly available, 24/7 servers on ethernets with bandwidths in excess of one gigabit per second (Gbps) or more as technologies improve. As such, the P2P network of the present invention represents peers as always-on peersonas rather than accessibly intermittent end-user devices. Thus, a user in the Peerouette-Net is always present by the user's peersona. Therefore, a peersona, or personal agent of the user, may be working on behalf of the user as a peer in the Peerouette-Net on a 24/7 basis regardless of whether the user is connected to the Peerouette-Net or a device of the user is connected to the Personal Server of the user.

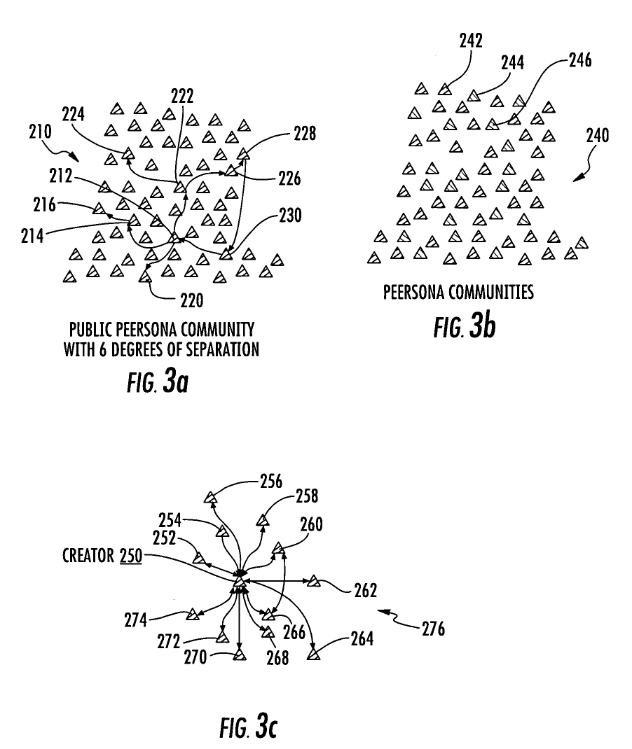

FIG. 3a is an embodiment of the separation of an association of a peersona community. Peersonas may be organized into communities or associations of related interest, relationships, or various other organizational factors. A single, default community, or peersona public, community, may be formed from all the peersonas on a Peerouette-Network. A peersona community may be a collection of peersonas having a common interest or goal. For example, peersona communities 242, 244, 246 are represented for a sample of peersonas 240 in FIG. 3b. The concept of P2P networking involves the ability to find a peer within the network or among a community. Without communities, peers are generally referred to being related by six degrees of separation, meaning it may require as many as five points of contact to identify a peer such that the sixth contact is the requesting peer. This concept is just a generalization for the breadth of difficulty presented to contact or find another peer in a traditional P2P network. By comparison, as shown in FIG. 3c, by creating peersona communities with a single peersona creator 250 which creates and maintains the community and keeps a list of its members, any peer may identify another peer within the community by contacting the creator peersona 250 to identify another peer within the community. For example, peersona 260 may contact the creator peersona 250 to determine the identity of peersona 268 within the peersona community 276. This organization of a peersona community provides a “one-hop” or single contact point discovery of peersonas in the community.

The creator peersona may create the community as a private community or organization of the peersona or may contact a community service, such as a Peerouette-Network Community Central Naming Authority or a global community naming authority, to establish a unique name for the community, such as community+peersonaIdentity. A community naming authority may also certify and/or register the community in a community name database in which each of the communities are uniquely identified, such as by a universal unique identifier (UUI) which may include or be bound to a universal unique name for the community. Peersona communities may be restricted as private, secure communities by the creator peersona or a Peerouette-Network community control server. A peersona community may be used to locate other peersonas and, for example, open an AOL® Instant Messanger® session with one or more members of the public or secure community.

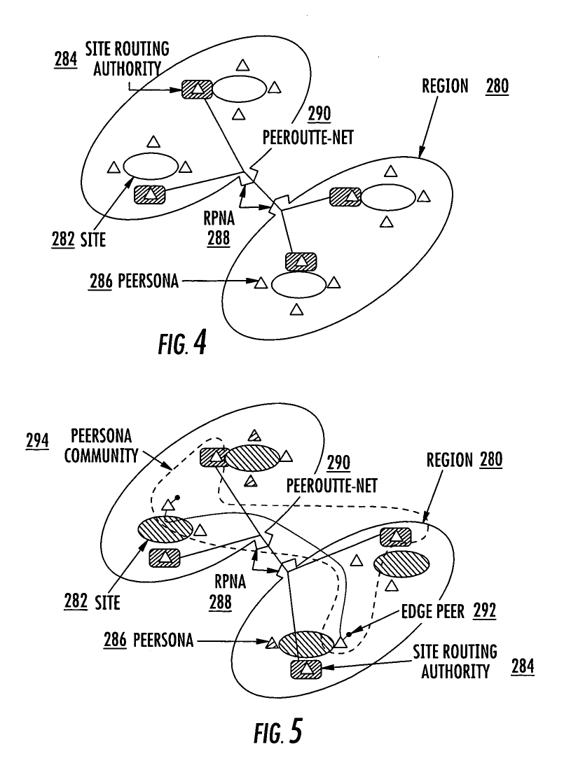

While peersonas may be organized into communities, Personal Servers and modulators are organized into sites 282 and regions 280 as shown in FIGS. 4 and 5. FIG. 4 shows peersonas, sites, and regions of a Peerouette-Net. FIG. 5 shows peersonas, sites, regions, and a peersona community of the Peerouette-Net. The peersona community 294 of FIG. 5 translates across the regions 280 to capture peersonas 286 of both regions. The peersona community organizing architecture is unrelated to the local and regional organization structure of sites and regions for routing. Rather, the local and regional organizational architecture of the Peerouette-Net provides for the routing of information between peersonas within and without sites and regions. For example, a regional Peerouette-Net authority (RPNA) 288 is used to transmit and receive routing information from and to its region of control. A site routing authority 284 is used to advertise the routing information required to contact and transmit messages to and from the modulators within the site. And a regional Peerouette-Net authority 288 would control publication of routing information to enable transmissions between modulators of sites in its region. By way of example, an edge-peer 292 contacts its peersona 286 to transfer or receive information to or from the network. The peersona 286, by way of its Personal Server, uses its modulator routing services for transferring information to and from the Personal Server. The modulator contacts its site routing authority 284 to obtain the routing information required for the transmission of information to and from the modulator. The site routing authority 284 contacts the regional Peerouette-Net authority 288 to obtain the routing information required to transfer of information to and from the site. Once a peersona acquires the fully qualified Peerouette-Net address and, therefore, route to a destination peersona in this manner, the peersona will have the IP address and port of the ultimate destination peersona and can transfer content directly to that peersona. If the destination is an edge-peer, then the content will arrive to a data message memory (Inbox) relative to the peersona community and/or service to which the edge-peer belongs and in which the edge-peer is active. Using an edge-peer to peersona protocol, the edge-peer can retrieve the content from the Inbox. Alternatively, for non-mobile edge-peers such as set top boxes, a Service Rendezvous Protocol between such an edge-peer and the destination peersona may yield the IP address and port of the destination edge-peer if direct communication is possible. In this instance, once this address is known, the content may be transferred directly to the destination edge-peer.

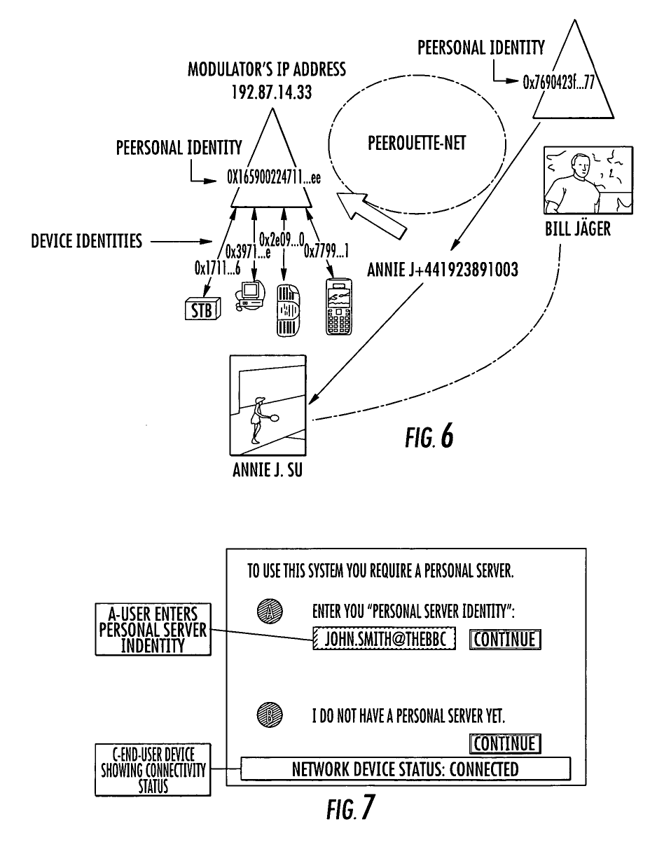

FIG. 6 is a diagram of a peersona in communication with another peersona. As previously mentioned each peersona is provided an identity or unique identifier for the user. This unique identifier of the peersona is the peersonaIdentity that is used by the modulator to provide routing information for other modulators, site routing authorities, and regional Peerouette-Net authorities. Further, each edge-peer of a user is provided an edgepeerIdentity. These identities may be machine generated by a Peerouette-Network control server such as a hosting central server or a central certificate authority server, thus ensuring that each of these identities is guaranteed to be a universal unique identifier (UUID). Alternatively, either a secure or pseudo random number generator may be used to generate universal unique identifiers twenty bytes in length that are guaranteed to be statistically unique. FIG. 6 provides an example peersona for Annie J. Su and communication between the peersonas of Annie J. Su and Bill Jäger. The name, nickname, or handle, for the peersona of Annie J. Su may be represented as AnnieJ if such name is uniquely available. A unique and personal identifier such as AnnieJ's mobile device integrated services digital network (MSISDN) number may be appended to the name AnnieJ to yield a unique name, or any universal unique identifier may be appended to a name of a peersona to yield a universal unique name for the peersona. The name may be appended or bound to the UUID of the peersona. Thus, a user's full Peerouette-Network identity would be the {peersona name, peersonaIdentity} pairing. To protect privacy of a user, a user's name for the peersona may not be presented to other users of the Peerouette-Net but only those which are authorized to know, search, and view the name for Annie J. Su's peersona. In such a manner, a user may remain unknown or anonymous to other users of the Peerouette-Net. A user may securely add a unique string to the peersona name that is only available to authorized users, and for which lookups will only succeed if the user looking up the peersona has been given lookup access by the named peersona network entity. Typically, an MSIDN, a home address, a secret and personal phrase, etc. may be used as a unique string. Furthermore, Peersona Central Services can certify this name as unique. If a user has been authorized to receive a response from a lookup of the user's peersona, a lookup such as of AnnieJ+441923891003, where +441923891003 is AnnieJ's MSISDN number, would yield the peersona Peerouette-Net address that includes the IP address of the modulator (192.87.14.33) and the peersonaIdentity (0×165900224711 . . . ee) of the peersona, such as of Annie J. Su's peersona. When a peersona is registered, descriptive information may be required such as the user's name, a nickname for the peersona, a mobile phone number, an email, and other related or similar information. This information would be stored with the peersonaIdentity generated for the peersona. To protect the privacy of a user, the user's name for the peersona may not be presented to other users of the Peerouette-Net but only those that are authorized to know, search, and view the name for Annie J. Su's peersona that includes the unique, descriptive information. In such a manner, a user may remain unknown or anonymous to other users of the Peerouette-Net. Such information is to be understood as examples and not limiting examples of information presented to register a peersona. With respect to FIG. 6, a dashed line is shown to represent that Bill Jäger, with a peersonaIdentity of 0×7690423f . . . 77, is part of Annie J. Su's Friends Network. This Friends Network may be a private peersona community of Annie J. Su which identifies particular peersonas or users are common to Annie J. Su's Friends Network, thereby possibly providing each of those individuals access to the name of Annie J. Su's peersona and the ability to search for Annie J. Su's peersona and retrieve the modulator IP address and peersonaIdentity for Annie J. Su's peersona on the Peerouette-Net. Each of the edge-peers of Annie J. Su are assigned a device identity or edgepeerIdenity for communication with the peersona. For example, Annie J. Su has a set top box, 0×1711 . . . 6; a personal computer, 0×3971 . . . e; a mobile phone and personal computer, 0×2e09 . . . e; and a mobile phone, 0×7799 . . . 1. In the above examples of identifiers for a modulator, peersonas, and devices, “ . . . ” is used to abbreviate the representation of a longer character string, typically a unique identifier or universal unique identifier.

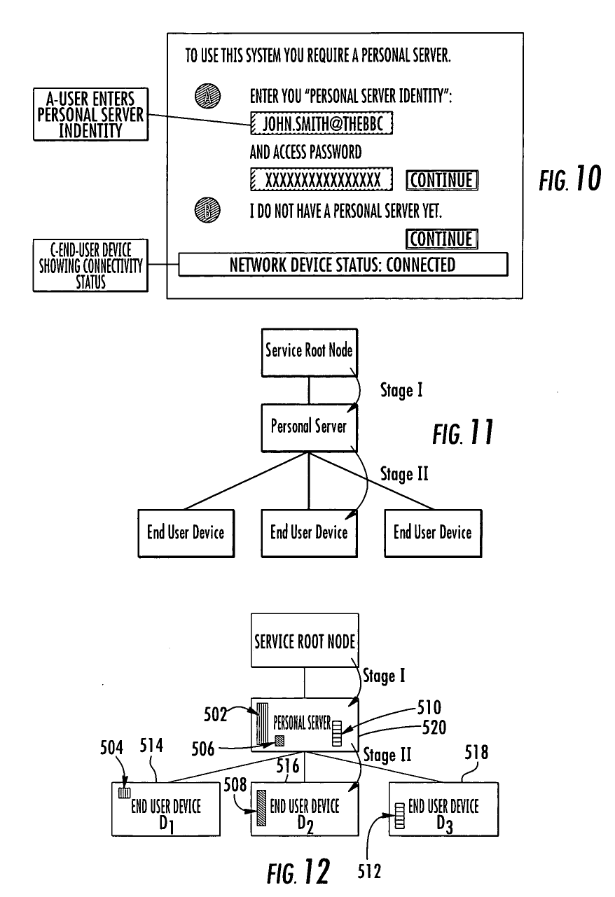

FIG. 7 is a device connection portal, typically generated by an edge-peer connecting to a peersona and displayed on the edge-peer for the user, using web access to a peersona. After creating a peersona, a user may wish to associate or connect end-user devices or edge-peers with the user's peersona. For example, a user trying to access the Peerouette-Net with a device may be presented with a notification that “To use this system you require a Personal Server” and a prompt for the user of the device to sign in to the network, shown as option A with the text “Enter Your “Personal Server Identity”:”, a text input box, and a Continue button, or a prompt for the user to register with the network, shown as option B with the text “I do not have a Personal Server yet” and a Continue button. Notification may be provided to the user regarding the status of the connection between the device and the network, such as an end-user device showing connectivity status with message text of “Network Device Statsus: Connected.” If no peersona exists when an end-user device connects to the Peerouette-Net, the user would be able to select that they do not have a Personal Server or peersona yet and such configuration would continue. Where a user does have a Personal Server identity, after connecting the end-user device to the Peersona-Net and entering the user's Personal Server identity or peersonaIdentity (John.smith@theBBC), the user may select to continue the process of connecting or associating the end-user device with the user's peersona. The user may access the user's Personal Server or peersona through a web interface or other interface either through the end-user device or separately. If through the end-user device attempting to be connected or associated with the peersona, the user would likely be required to enter a password to ensure that the user of the peersona is actually connecting or activating the new end-user device. If the user is accessing his or her Personal Server or peersona such as through a web access, a Personal Server Management Console may be used to show the user that a new device is waiting to be peered with his or her Personal Server. A Personal Server Management Console may be a user interface to access, view, control, and modify a peersona. For example, the Personal Server Management Console portal shown in FIG. 10 allows a user to view the communities and devices associated with his or her peersona and to select functions or services available for his or her peersona, such as creating or joining a community, adding a new application, managing an application, and accessing services such as mail, personal assistant, phone, file sharing, and chat.

FIG. 8 shows a community, device connection, and services and application portal, typically generated by a Personal Server and displayed on an end-user device or through peersona web access portal, of a peersona seen from a Personal Server Management Console. If a request is made from an end-user device as shown in FIG. 7 where the user does not authorize the connection or association directly from the end-user device, the user may need to access his or her Personal Server Management Console such as shown in FIG. 8 to identify that a new device is waiting or has requested to be associated with the user's peersona. For example, a spouse may request his or her end-user device be associated with a family peersona controlled by his or her spouse. By requiring a password known only to the user of the peersona, security may prevent someone from associating an unauthorized device with a peersona and to support control of the devices associated with a peersona. Thus, embodiments of the present invention may be used to allow authorization of association of an edge-peer with a peersona from an end-user device and embodiments to allow a request for association between an edge-peer and a peersona where the user of the end-user device does not have supervisory control of the peersona. The Personal Server Management Console of FIG. 8 shows a user's communities, labeled “My Communities”, as “My Family”, “My Friends”, and “My Colleagues” and an option to “Create Community”. Further, a user's “My Communities” may include an option to view “Other Communities” or to “Join a Community” such as the “GSMWorld”, “Bill's Friends”, or “BBCi” communities. The Personal Server Management Console of FIG. 8 also shows a user's devices, labeled “My Device Family”, as “PowerBook G4”, “HP Jornada 500”, “BBC-V STB”, and “Dell 260XL”. For each device, the Personal Server Management Console may indicate the activity status of each device, such as that a device is “Active”, “Last Active 5 days ago”, or “Last Active yesterday”. The Personal Server Management Console may also indicate to the user if activity status of a device cannot be updated such as with “Cannot update”. If a new device has requested to join the peersona, the Personal Server Management Console may show the “New Device” as “waiting to join . . . ” the peersona, such as a set top box that has requested to be peered with a Personal Server of a user. A Personal Server Management Console may also show what services and applications are available to a user, labeled as “My Services & Apps”. For example, available services may include “Mail”, “Personal Assistant”, “Phone”, “File Share”, “Alias”, “Locate Me”, and “Chat”. Additional functions may be provided to “Add New Application” to the Personal Server, to “Manage Applications” of the Personal Server, or select to work with other “Apps&Services” features.

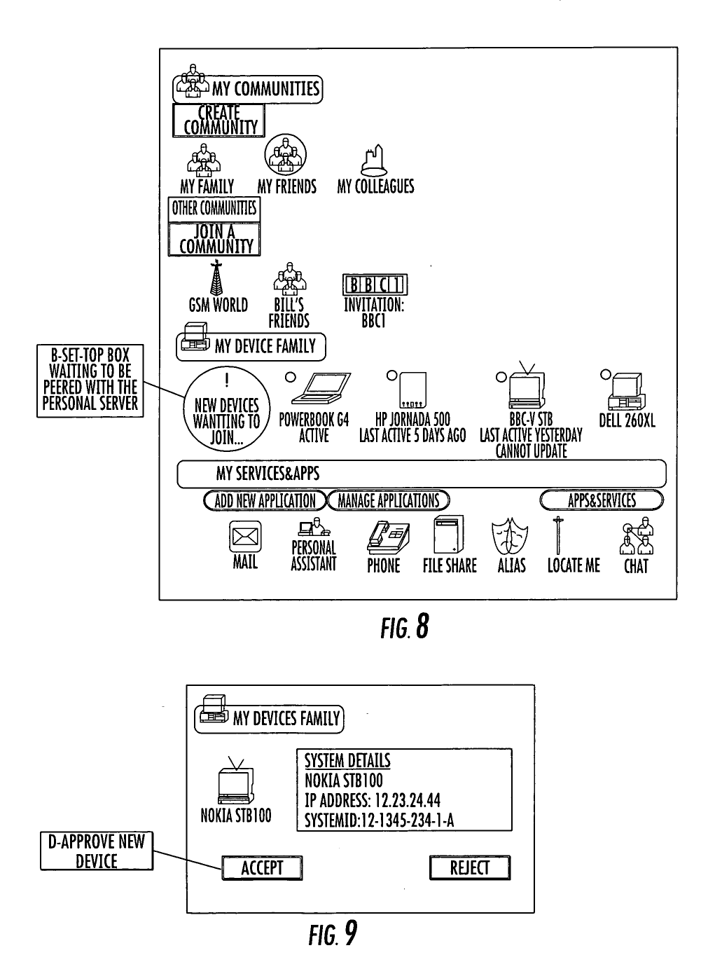

FIG. 9 is an acceptance portal, typically generated by an edge-peer connecting to a peersona and displayed on the edge-peer or generated a Personal Server Management Console and displayed through a peersona web access portal, of a device connection to a peersona. From the Personal Server Management Console of FIG. 8, a user may select to authorize or reject a request for association of a new device as shown in FIG. 9. For example, if a user selects a “New Devices waiting to join . . . ” icon, as shown in FIG. 8, a “New Devices” portal may be presented to the user. An acceptance portal may provide further information about the new device, such as a name, “Nokia STB100”, and system details, “Nokia STB100, IP Address: 12.23.24.44, SystemID: 12-1345-234-1-A”. This information may be used by the user to determine whether to approve the association with the new device such as selecting an “Accept” or “Reject” button. By comparison, FIG. 10 is a device connection portal, typically generated by an edge-peer connecting to a peersona and displayed on the edge-peer or generated a Personal Server Management Console and displayed through a peersona web access portal, requesting a peersonaIdentity and password for a connection to a Personal Server. In this case, the user of the peersona is authorizing the connection of the new end-user device to the peersona by entering both the Personal Server identity and an access password to authorize the association. For example, a user trying to access the Peerouette-Net with a device may be presented with a notification that “To use this system you require a Personal Server” and a prompt for the user of the device to sign in to the network, shown as option A with the text “Enter Your “Personal Server Identity”:”, a text input box, and a Continue button, or a prompt for the user to register with the network, shown as option B with the text “I do not have a Personal Server yet” and a Continue button. If the user of the device enters a Personal Server identiy, the device connection portal may provide a text input box for the user to enter the password for the Personal Server, such as indicated by “and Access Password” to alert the user that a password must also be entered to authorize the device. Notification may be provided to the user regarding the status of the connection between the device and the network, such as an end-user device showing connectivity status with message text of “Network Device Statsus: Connected.” One of ordinary skill in the art will understand that various other types of requests and authorizations may be used for associating an end-user device with a peersona.

FIG. 11 is a block diagram of two stages of the process of service or content configuration of a Peerouette-Net. By using a separate Personal Server or peersona located on a modulator and end-user devices or edge-peers, the services and content used and provided to the user are performed or passed through two stages. The first stage is from a service route node or other external server, such as another peersona stored by the modulator or an external content server, to the Personal Server. The second stage is from the Personal Server to the end-user device. In order to ultimately reach the user, a content or service function may be performed and/or produced by a service or content provider route node system and consumed by the Personal Server, and then performed and/or produced by the Personal Server system and consumed by the end user. This layered approach to an always-on Personal Server to represent the peersona and user interaction through end-user devices presents two-stage content download, two-stage application upgrade or update, two-stage application execution, and two-stage configuration management. Various other two-stage functionalities may be performed by the Personal Server and end-user devices. By way of further example, in a two-stage content download, content may originally be presented in full to the Personal Server and then consumed in real time by an end-user device rather than downloading the entire multimedia content file to the end-user device. However, by downloading the entire multimedia file to the Personal Server, the user will be able to share the content with other peersonas or retrieve the content when using other end-user devices. In some respects, the Personal Server is a storage medium for content of a single user in order to allow the user to be able to access all of the user's peersona information, data, and content from a single source with various end-user devices. However, in addition to a single storage source, the Personal Server provides increased reliability for the Peerouette-Net by presenting an always-on network representation of the user in the form of the peersona. In addition, by separating the Personal Server from the end-user device and representing the user in the network by the peersona of the Personal Server, features such as distributing content, upgrading or updating computer program codes such as application software or operating systems, and configuration management of the network and entities thereof is simplified by allowing control servers of the broader Peerouette-Network environment to communicate with the Personal Server without being required to communicate with an end-user device which may or may not be available at the time of the upgrade. Further, by presenting multiple Personal Servers on a single modulator entity, control servers of the broader Peerouette-Network are able to ultimately contact fewer entities by only being required to contact each of the modulators rather than having to contact each of the Personal Servers or every end-user device on the entire system. Once the upgrade, content, configuration, or other control functionality has been presented to the modulator, the modulator can then perform any further required functionality such as determining whether or not each of the associated end-user devices of the Personal Servers resident on the modulator need to be upgraded or modified in any way based upon the information provided originally to the modulator. Similarly, a two-stage application execution may allow certain software modules to only be required to be resident on the Personal Server and not required to be downloaded and run on the end-user devices.

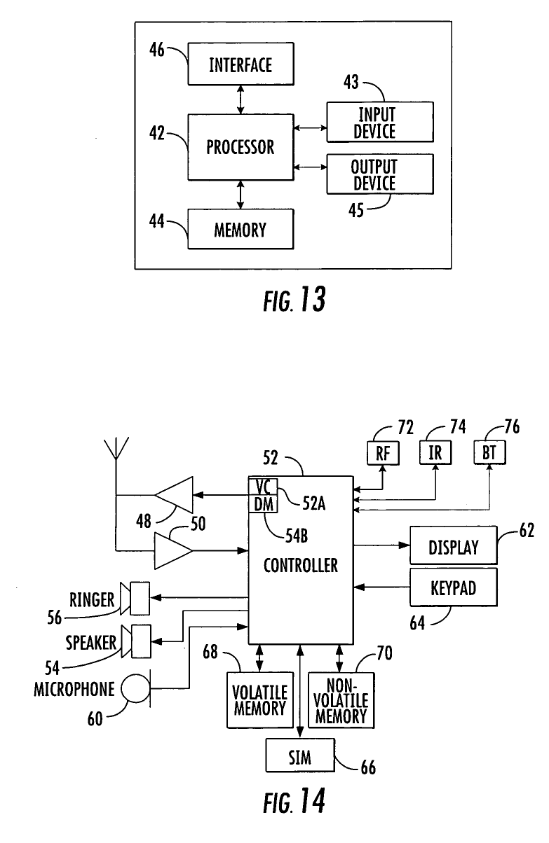

FIG. 12 is a block diagram of two stages of computer program code updating and service configuration management of a Peerouette-Net. As described with reference to FIG. 11, by separating the Personal Server and peersona from the end-user devices, all activity which must be performed on the end-user device passes through the Personal Server, but changes to the Personal Server do not necessarily affect each or any of the end-user devices. As shown in FIG. 12, a Personal Server receives data or software bundles or modules 502, 506, 510. In the example of FIG. 12, each of the end-user devices is associated with one of the data or software bundles or modules. For example, a first end-user device D₁ 514 may include computer program code 504 associated with computer program code 502 on the Personal Server 520. The computer program code 504 on end-user device D₁ 514 may be a portion of the computer program code 502 on the Personal Server 520 which has been partially downloaded by the end-user device D₁ 514, or may be an associated segment of a software application which has been partitioned or divided between the Personal Server 520 and the end-user device D₁ 514. A second end-user device D₂ 516 may include multimedia data 508 associated with multimedia data 506 on the Personal Server 520. When the end-user device D₂ 516 connects to the Personal Server 520, the Personal Server 520 may identify that a download of multimedia content was interrupted when the end-user device D₂ 516 was previously disconnected from the Personal Server 520. Thereby, the Personal Server 520 may download or transfer the remaining portion of the content 506 received by the Personal Server 520. Alternatively, the end-user device may determine whether or not it wishes to continue the download of the interrupted content download and retrieve the remaining media content 506 from the Personal Server 520. A third end-user device D₃ 518 may include computer program code 512 which is a different version from the computer program code or content 510 on the Personal Server 520. The Personal Server 520 may have received the computer program code 510 as an update or upgrade to the computer program code 512 previously provided to the Personal Server 520 and subsequently to the end-user device D₃ 518. When the end-user device D₃ 518 connects to the Personal Server 520, the Personal Server 520 may identify that the end-user device D₃ 518 maintains an older version of the computer program code 510 recently received by the Personal Server 520 and download or replace the computer program code 512 on the end-user device D₃ 518 with the newer computer program code 510 on the Personal Server 520.

Reference is now made to FIG. 13, which illustrates a block diagram of an entity capable of operating as a network node such as a global community naming authority in accordance with the present invention or a network node of a Peerouette-Network (e.g., Personal Server, Modulator, Regional Peerouette-Net Authority, Hosting Central Server, Content Server, etc.). Although shown as separate entities, in some embodiments, one or more entities may support one or more of the network nodes, logically separated but co-located within the entity or entities, such as a global community naming authority and a Peerouette Community Naming Authority or multiple Peersonal Servers located on a common modulator.

As shown, the entity capable of operating as a network node can generally include a processor, controller, or the like 42 connected to a memory 44. The processor can also be connected to at least one interface 46 or other means for transmitting and/or receiving data, content, or the like such as a network connection or wireless connection. The memory 44 can include volatile and/or non-volatile memory and typically stores content, data, or the like. For example, the memory 44 typically stores computer program code such as software applications or operating systems, information, data, content, or the like for the processor 42 to perform steps associated with operation of the entity in accordance with embodiments of the present invention. Also, for example, the memory 44 typically stores content transmitted from, or received by, the network node. Memory 44 may be, for example, random access memory (RAM), a hard drive, or other fixed data memory or storage device. The processor 42 may receive input from an input device 43 and may display information on a display 45. Where the entity provides wireless communication, such as a mobile network, the processor 42 may operate with a wireless communication subsystem (not shown), such as a cellular transceiver, in the interface 46. Mobile network includes a cellular network, and may also include a private network using such communication technologies as IR, BT, or the like. One or more processors, memory, storage devices, and other computer elements may be used in common by a computer system and subsystems, as part of the same platform, or processors may be distributed between a computer system and subsystems, as parts of multiple platforms.

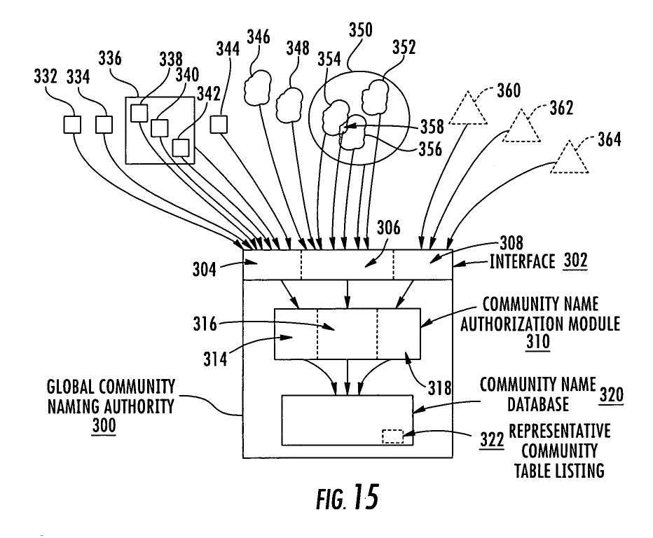

FIG. 14 illustrates a functional diagram of a mobile device that may operate as a mobile terminal 32 and, as such, an end-user device or edge-peer according to embodiments of a Peerouette-Network and to function with a global community naming authority of embodiments of the present invention. It should be understood, that the mobile device illustrated and hereinafter described is merely illustrative of one type of mobile terminal that would benefit from the present invention and/or a Peerouette-Network and, therefore, should not be taken to limit the scope of the present invention. While several embodiments of the mobile device are hereinafter described for purposes of example, other types of mobile terminals, such as portable digital assistants (PDAs), pagers, laptop computers, and other types of voice and text communications systems, can readily be employed to function with the present invention and/or a Peerouette-Network.

The mobile device includes a transmitter 48, a receiver 50, and a controller 52 that provides signals to and receives signals from the transmitter 48 and receiver 50, respectively. These signals include signaling information in accordance with the air interface standard of the applicable cellular system, and also user speech and/or user generated data. In this regard, the mobile device can be capable of operating with one or more air interface standards, communication protocols, modulation types, and access types. More particularly, the mobile device can be capable of operating in accordance with any of a number of 1G, 2G, 2.5G and/or 3G communication protocols or the like. For example, the mobile device may be capable of operating in accordance with 2G wireless communication protocols IS-136 (TDMA), GSM, and IS-95 (CDMA). Also, for example, the mobile device may be capable of operating in accordance with 2.5G wireless communication protocols GPRS, Enhanced Data GSM Environment (EDGE), or the like. Some narrow-band AMPS (NAMPS), as well as TACS, mobile devices may also benefit from embodiments of the present invention, as should dual or higher mode mobile devices (e.g., digital/analog or TDMA/CDMA/analog phones).

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionally to operate one or more software applications, which may be stored in memory.

The mobile device also comprises a user interface including a conventional earphone or speaker 54, a ringer 56, a microphone 60, a display 62, and a user input interface, all of which are coupled to the controller 52. The user input interface, which allows the mobile device to receive data, can comprise any of a number of devices allowing the mobile device to receive data, such as a keypad 64, a touch display (not shown), or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys.

The mobile device can further include an IR transceiver 74 or another local data transfer device so that data can be shared with and/or obtained from other devices such as other mobile devices, car guidance systems, personal computers, printers, printed materials including barcodes, and the like. The sharing of data, as well as the remote sharing of data, can also be provided according to a number of different techniques. For example, the mobile device may include a radio frequency (RF) transceiver 72 capable of sharing data with other radio frequency transceivers, and/or with a Radio Frequency Identification (RFID) transponder tag, as such is known to those skilled in the art. Additionally, or alternatively, the mobile device may share data using Bluetooth (BT) brand wireless technology developed by the Bluetooth Special Interest Group and a BT transceiver 76. Further, the mobile device may be capable of sharing data in accordance with any of a number of different wireline, proximity, and/or radio wave networking techniques, including LAN and/or WLAN techniques.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application, such as a software program or modules for an application, and may store an update for computer program code for the mobile device.

FIG. 15 is a block diagram of a global community naming authority of an embodiment of the present invention in communication with existing online communities, non-formalized communities, and new communities in accordance with the present invention. A service provider may be an embodiment of a global community name authority in accordance with the present invention. A global community naming authority 300, shown without hardware elements such as a memory or a processor, may include a network interface 302, a community name authorization module 310, and a community name database 320. A community name authorization module of an embodiment of the present invention may be a software program or module resident in memory, either in or communicably connected to a global community naming authority, such as in a resident hard drive or on a networked file server, capable of operating with a processor and a community name database of a global community naming authority. A community name database of an embodiment of the present invention may be a software database resident in memory, either in or communicably connected to a global community naming authority, such as in a resident hard drive or on a networked file server, capable of operating with a processor and a community name authorization module of a global community naming authority. A network interface may be hardware and/or software elements that provide a communication connection between a global community naming authority and network nodes or entities of a network. A network interface 320 may be partitioned to accept different types of communications and input. For example, a partition 304 of a network interface 302 may provide communication with and accept input from existing communities 332, 334, 338, 340, 342, 344, and group or community portals 336. A second partition 306 of a network interface 302 may provide communication with and receive input from non-formalized communities 346, 348, 350, 352, 354, 356, 358. A non-formalized network interface partition 306 may communicate with entities such as social membership organizations and corporations to provide migration and creation of online communities of the non-formalized communities represented by these and similar types of organizational structures. A third partition 308 of a network interface 302 may provide communication with and receive input for new communities 360, 362, 364. A network interface 302, or partitions thereof 304, 306, 308, may communicate with a community name authorization module 310. The communication between a network interface 302 and a community name authorization module 310 may actually occur by means of a memory and a processor (not shown), as may any type of communication or data transmitted within a global community naming authority 300. A community name authorization module 310 may be segmented or partitioned similarly to a network interface 302. For example, a community name authorization module 310 may include a processor operating under the control of a computer program code, generally stored by memory accessible by the processor of the global community naming authority 300, specifically designed for handling services and functions for existing communities 314, non-formalized communities 316 and new communities 318. A community name authorization module 310 of a global community naming authority 300 may communicate with a community name database 322 such as to add or delete community registrations from the database. One of ordinary skill will recognize that a community name authorization module 310 may communicate with a community name database 320 to perform any type of service or function related to the services and functions provided by a global community naming authority 300, including adding or deleting registered communities, certifying or registering a community, and managing registered communities.

As shown in FIG. 15, a user group portal or community modulator 336, such as groups.Yahoo.com or groups.MSN.com, that controls multiple groups or communities 338, 340, 342 may register each of the communities 338, 340, 342, and also the group portal 336, with a global community naming authority 300 of an embodiment of the present invention. Similarly, a corporation 350 comprising multiple organizational communities 352, 354, 356, 358 may migrate and register these non-formalized communities 352, 354, 356, 358 with a global community naming authority 300 of an embodiment of the present invention. As shown in FIG. 15, non-formalized communities 354, 356 may overlap or share commonalities of users which may create another community 358. This type of overlap of communities creating another community can be found in existing communities, non-formalized communities, or new communities. However, just because users may overlap between multiple communities the overlap may not be intended as a further community. For example, a corporation 350 may not intend that an overlap community 358 be migrated. Rather, such an occurrence may exist simply because a group of users is common to multiple communities 354, 356. Just as a group portal 336 may register with a global community naming authority 300, a corporation or division of a corporation such as a community 350, which may contain sub-communities 352, 354, 356, 358, may migrate such a non-formalized community 350 with a global community naming authority 300 of an embodiment of the present invention.

Communities, such as peersona communities, may be used to create a boundary for a virtual private network of the members of the community. Security for such a type of community may be provided in the registration with the global community naming authority of an embodiment of the invention. Similarly, a global community naming authority of an embodiment of the present invention may facilitate the implementation of other types of privacy schemes and digital rights management. For example, all of the members of a particular community may be provided digital rights for access to or sharing of particular content, such as all of the content provided by a content provider that has created this particular community for all of its users.

Each community as registered with a global community naming authority of the present invention may be assigned a universal unique identifier (UUID). Further, each community may include a name as either part of the universal unique identifier or separate from the universal unique identifier of the community. For example, a peersona community may be assigned a peersona community identifier peersonaCommunityIdentifer (PCOMID). A universal unique identifier for a community may be denoted by a hexadecimal string such as generated by a secure hash algorithm (SHA) pseudo random number generator of a community name authorization module or community name database. As previously mentioned, a universal unique identifier for a community may include the name of the community, for example a hexadecimal community universal unique identifier may be appended with a name for the community, where such name may also be a universally unique identifier, referred to herein as a universal unique name. By registering communities with a global community naming authority of the present invention, the creator or owner of a community may be ensured that the community is assigned a universal unique identifier and possibly a universal unique name. Further, a global community naming authority of the present invention may provide for other descriptive information about the community to be registered with the community in a community name database. For example, a community name database may include bindings for the community such as the universal unique identifier, universal unique name, and other descriptive information about the community. By registering a community with a global community naming authority, a creator or owner of a community may select whether or not the community will have either anonymous, registered, or qualified security format. If an anonymous is selected, the community may be advertised publicly such as through a search for a particular type of community represented by a particular name or descriptive feature related to the community as may be represented in a binding with the community in a community named database of an embodiment of the present invention. Membership is anonymous and open to all peersonas. If a registered community is selected, then membership and activities within the community may be monitored with periodic reports to the community owner. If a qualified community is selected, then membership is privately controlled, and participation may be subject to strong authentication. Also, a search for qualified communities may not identify the community. The Peerouette-Net supports the public community as part of its infrastructure. All peersonas are members, and it is within the public community that one can search for anonymous and registered communities. Qualified communities may or may not be publicly advertised.

In one example embodiment of a community name database of a global community naming authority of the present invention, each community may be represented by a document as a record in the database. Such a document may include the universal unique identifier for the community along with other information about the community to create bindings between such information for the community. One example embodiment of a document for a community name database of a global community naming authority the present invention is provided below. The example is provided for a peersona community in the context of a global community naming authority included in the framework of a Peerouette-Network.

<?xml version=“1.0” encoding=“UTF-8”?>
<!DOCTYPE Peerouette:peersonaCommunity>
<Peerouette:peersonaCommunity xmlns:Peerouette=http://Peerouette.com>
<name>
<text> Legal XML String </text> | certified name
</name>
<peersonaCommunityIdentity>
uuid:<legal hexadecimal string>
</peersonaCommunityIdentity>
<type> ANONYMOUS | REGISTERED | QUALIFIED </type>
<policy> URI for the access control policy </policy>
<description>

<URI> URI description </URI>
<text> Legal XML string description </text>

</description>
<services>

<URI> URI for service1 </URI>

:

<URI> URI for serviceN </URI>

</services>
<creator>
<peersona> uuid:peersonaIdentity </peersona>
<modulator> uuid:modulatorIdenity </modulator>
<site> uuid:siteIdentity </site>
<RPNA> uuid:RPNAIdentity </RPNA>
</creator>
<XMLSignature> {per RFC 3275} </XMLSignature>
</Peerouette:peersonaCommunity>
certified name :=

<certified>

<text> Legal XML String </text>
<xmlsignature> {per RFC 3275} </xmlsignature>

</certified>

A community name typically may be a certified name that provides a universal unique name (UUN) for the community. The name may be part of the universal unique identifier for the community, such as { uuid:<legal hexadecimal string+UUN>} or may be a separate universal unique name. If the name is not certified as a universal unique name, the document for the community would not include an identifier that the name is certified. Thus, embodiments of the present invention may provide the ability to require all names of communities to be universal unique names or to allow names not to be certified and possibly have duplicates across multiple communities. Community creators may create ad-hoc communities without certification of the names. But although communities may be created without certifying the community name, thus possibly creating multiple communities with the same name, only one community may be certified with that name. Thus, if in individual is searching for a particular community, a search may be restricted to only communities with certified names. Alternatively, one method of certifying a name for a community may be to allow the community creators to select names for the communities and then append the names with a universal unique identifier, either of the community or a separate universal unique identifier, to create a universal unique name. For example, a community creator may select Classical Music for the name of the community, but to certify the name, a global community naming authority may append a certified, universal unique identifier to the name, such as Beethoven's birthday {ClassicalMusic+Dec. 16, 1770}. A community name typically is user friendly. One of ordinary skill in the art will note that certification does not guarantee uniqueness. Rather, certification guarantees certifiably unique names. Another certification scheme for names may be to include an existing name where such combination does not create certified duplicates. For example, as part of registering existing communities, universal unique names may be created by appending the name of a group portal to the community name such as Yahoo:ClassicalMusic, Yahoo:RockMusic, MSN:ClassicalMusic, MSN:RockMusic, iMac:RockMusic, and iMac:iTunes. Alternatively or additionally, naming of communities and certifying universal unique names for communities may take advantage of existing naming schemes such as domain and subdomain names, such as BBC.co.uk, Nokia.com, sports.Yahoo.com, and launch.Yahoo.com and BBC.co.uk:News, Nokia.com:News, sports.Yahoo.com:News, and launch.Yahoo.com:News. Using domain names to form part of the community names may help to simplify the migration of existing online communities into a community name database of a global community naming authority of an embodiment of the present invention. For private communities, a personalization of a user or peersona may be used to certify a name, such as using the modular or mobile station ISDN number (MISDN) of the user or the peersonaIdentity. For example, a user may create a Stanford Tennis community with a universal unique name of StanfordTennis+441932985555 or StanfordTennis+52f201ac-22cf-21d1-b12d-002035b23010.

As provided in the example document of a community name database of a global community naming authority of an embodiment of the present invention, a “type” field may have any values desired for identifying the community on the system. Types provided in the example are Anonymous, Registered, and Qualified. An anonymous community may allow any user to join the community without identifying him or herself to other users of the community; a registered community may allow any user to join the community by disclosing the identity of the user to the other users of the community and permitting the community activities of the members to be monitored; a qualified community may limit what users are able to join the community based on any type of restrictive scheme such as allowing the creator to invite users or allowing users to request approval to access the community. A qualified community may also have strong authentication requirements for participation. These characteristics may be included in a policy field where a “policy” field may reference a URI for joining or using a community such as referencing a Java code that is downloaded and run for gaining access to the community or resources thereof. A “description” field may be used to provide a textual description of the community. A “services” field may be used to identify services or functions available by the community such as browsers, content players, chat services, and instant messaging services. A “creator” field may be used to preserve the identity of the user, peersona, group portal, or other entity that creates a community. The example above is not meant to be limiting of the form of storage or type of information that may be stored in a document for a community. One of ordinary skill in the art will recognize other forms and formats of storing community information, other community information that may be stored for a community, and that the example fields provided above are not all required for implementation of an embodiment of the present invention.

A global community naming authority, and a Peerouette-Network Community Central Naming Authority, may certify, issue, register, maintain, verify, and revoke unique names and community identifiers. A community naming authority provides a different service and function than user identity schemes, such as Microsoft® .NET Passport or a Peerouette-Network Peersona Management System, and top-level domain (TLD) initiatives, such as initiatives and management of global top level domains (gTLDs) such as .com, .net, and .mob and of country code top level domains (ccTLDs) such as .uk, .fi, and .ch. A community naming authority, such as a global community naming authority provides services and functionality for communities of users, such as to provide certification and management of community identifiers and names. For example, embodiments of a global community naming authority of the present invention allow for existing communities to interface with a global community naming authority and migrate existing communities from an originator system into a global community naming authority for certification and registration in a global community name database. Further, embodiments of the present invention can manage communities within the a network framework including a global community naming authority, such as a Peerouette-Network, and from other network systems such as an external group portal, such as groups.Yahoo.com.

Even where communities may not be formally established as an online community, such as corporate organizational structure communities and social membership group communities, these communities may easily be mapped for the purpose of creating online communities. Such mapping may be performed by a global community naming authority of an embodiment of the present invention. Mapping may include the process of identifying a user space (or collection of users) or corporate or social organizational structure and creating an online community to represent such user space or structure. Mapping may define a community for creating an online community by identifying users that share predefined commonalities, such as association or employment with a particular organization or corporation, or predefined common features, such as sharing files within a particular discussion group. Where a community is created by mapping a non-formalized community, mapping may include associating network identities of the included users to the newly created community, thereby translating the user space or community and grouping of associated users into an online community populated with the representative non-formalized community users. Further a global community naming authority of an embodiment of the present invention may provide or create a universal unique identifier for newly formed, created, or mapped communities.

Communities may remain unregistered, such as private peersona communities and existing, non-formalized, or new communities that choose not to acquire a certified, universal unique identifier for such communities. These communities may be unknown or known only to those users associated with the community creator or a site monitor such as groups.Yahoo.com. However, a global community naming authority is intended to provide efficient and effective services and functions for registered communities and may be used to provide such services and functions for all communities as a means of bringing together these services and functions for all users that may want to join or be associated with any community. Particularly with use of such a global P2P network as the Peerouette-Network, it is intended that most community creators and monitors will want to register all communities with a global community naming authority to provide access to such communities for users of a global P2P network. Creators and monitors that do not register their communities will not be joining the larger association and collection of communities, thereby possibly precluding such users of a global P2P network from associating their user identity, such as a peersona, of the network with these unregistered communities. Rather, users will be forced to communicate directly with such community creators and monitors instead of having the simple ability to associate such communities with their global P2P network user identity. The right to anonymous communities, in the tradition of P2P networks, may be supported by embodiments of the present invention. All peersonas may be required to belong to at least one known peersona community as a requirement to join the Peerouette-Net. But, peersonas may not be required to participate in that community. Private communities, if created, may be used with peersonas and may generate revenue for network operators. For example, a user's community of family or friends may only be known to that user's family or friends, and yet the user creating the community may be charged for creating the community as well as for the number of members in the community. The community's existence may simply never be published in such a way that it may be discovered by a search for communities.

Users may, as presently available, be members of multiple communities and active in several at one time. However, by using a peersona, a user may associate a single network entity with multiple communities, including across multiple group portals, networks, or systems. Further, by using a global community naming authority of the present invention, a user or peersona may be able to coordinate, search, or associate all of the registered online communities.

One of ordinary skill in the art will recognize that the present invention may be incorporated into hardware and software systems and subsystems, as well as various other applications, and embodied as or incorporated into a network or group of networks. In each of these systems as well as other systems, including dedicated systems, capable of hosting the system and method of the present invention as described above, the system generally can include a computer system including one or more processors that are capable of operating under software control to provide the techniques described above, including, for example, a global community naming authority as shown in FIG. 15 including, without limitation, a community name authorization module, a network interface, and a community name database. Further, for example, a network node as shown in FIG. 21 may include a computer system including memory, a processor, and interface.

These computer program instructions may be loaded onto a computer or other programmable apparatus to produce a machine, such that the instructions which execute on the computer or other programmable apparatus create means for implementing the functions described herein. These computer program instructions may also be stored in a computer-readable memory that can direct a computer or other programmable apparatus to function in a particular manner, such that the instructions stored in the computer-readable memory produce an article of manufacture including instruction means which implement the function described herein. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein. It will also be understood that each block or element, and combinations of blocks and/or elements, can be implemented by special purpose hardware-based computer systems which perform the specified functions or steps, or combinations of special purpose hardware and computer instructions.

Herein provided and described are improved systems for global community naming authority and methods for naming global communities. A global community naming authority of an embodiment of the present invention may be used with online communities such as P2P network, corporate organizational structures, social classifications, structures, and memberships, and other online, electronic, and/or networked communities. A global community naming authority may register existing communities, map non-formalized communities, and manage the creation of new online communities. Embodiments of the present invention provide a single community naming authority to coordinate, certify, and authorize existing and new online communities.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A global community naming authority, comprising:
a memory;
a processor interoperably coupled to said memory;
a network interface interoperably coupled to said processor;
a community name database interoperably coupled to said processor, wherein said processor is capable of accessing, searching, or modifying said community name database;
a community name authorization module interoperably coupled to said processor, wherein said processor is capable of processing requests for community names received through said network interface with said community name authorization module.

2. The system of claim 1, wherein said community name database comprises a record for every registered online community.

3. The system of claim 1, wherein said processor is further capable of adding or deleting records from said community name database.

4. The system of claim 3, wherein said community name authorization module provides community name information to said processor for adding a new record to said community name database.

5. The system of claim 1, wherein said community naming authority is capable of generating universal unique identifiers for online communities registered with said community naming authority.

6. The system of claim 5, wherein at least one of said universal unique identifiers comprises a universal unique name for one of said online communities registered with said community naming authority.

7. The system of claim 1, wherein said community naming authority is capable of generating universal unique identifiers and universal unique names for online communities registered with said community naming authority.

8. A method of naming global communities, comprising the steps of:
migrating existing online communities into a global community name database;
assigning each of said existing online communities a universal unique identifier, wherein said universal unique identifier for each of said existing online communities may be stored in said global community name database as a binding of said existing online community; and
registering new online communities in said global community name database with universal unique identifiers for said new online communities.

9. The method of claim 8, wherein said universal unique identifiers of said existing online communities and said new online communities comprise universal unique names.

10. The method of claim 8, further comprising the step of assigning each of said existing online communities a universal unique name, wherein said universal unique name is stored in said global community name database as a binding of said existing online community and said universal unique identifier for said existing online community.

11. The method of claim 8, further comprising the step of registering each of said new online communities with a universal unique name, wherein said universal unique name is stored in said global community name database as a binding of said new online community and said universal unique identifier for said new online community.

12. The method of claim 8, further comprising the step of certifying an existing or new community of an external system or network.

13. The method of claim 8, further comprising the step of managing an existing or new community of an external system or network.

14. The method of claim 8, further comprising the step of mapping non-formalized communities into registered online communities in said global community name database with a universal unique identifier for each of said registered online communities of said mapped non-formalized communities.

15. The method of claim 8, further comprising the step of adding online communities to said global community name database.

16. A method of naming global communities, comprising the steps of:
receiving a request for naming an online community;
assigning a universal unique identifier to said online community of said request; and
registering said online community of said request in a global community name database, wherein said universal unique identifier is a binding of said registered online community.

17. The method of claim 16, further comprising the step of providing said request for naming an online community.

18. The method of claim 17, wherein said online community is an existing online community.

19. The method of claim 18, further comprising the step of generating said request for an online community for an existing online community.

20. The method of claim 16, wherein said universal unique identifier comprises a name.

21. The method of claim 16, further comprising the step of assigning a universal unique name to said online community of said request, wherein said universal unique name is a binding of said universal unique identifier and said registered online community.

22. The method of claim 16, further comprising the step of certifying an existing or new community of an external system or network.

23. The method of claim 16, further comprising the step of managing an existing or new community of an external system or network.

24. A service provider for naming and/or managing global communities, comprising:
an interface for receiving a request for naming an online community;
a processor logic for assigning a universal unique identifier to said online community of said request; and
a processor logic for registering said online community of said request in a global community name database, wherein said universal unique identifier is a binding of said registered online community.
